(19) United States
(12) Patent Application Publication
(10) Pub. No.: US 2025/0019206 A1
(43) Pub. Date: Jan. 16, 2025

(54) ELEVATOR CONNECTOR WITH ALIGNMENT FEATURE

(71) Applicant: OTIS ELEVATOR COMPANY, Farmington, CT (US)

(72) Inventor: Kyle B. Martin, Avon, CT (US)

(21) Appl. No.: 18/222,189

(22) Filed: Jul. 14, 2023

(51) Int. Cl. B66B 7/12; B66B 7/06; B66B 19/02

(52) U.S. Cl. CPC B66B 7/1223; B66B 7/062; B66B 19/02

(57) ABSTRACT

A connector comprises a body defining an internal cavity configured to receive a suspension member of an elevator system, and at least one suspension member alignment feature formed on an inner wall surface that surrounds the internal cavity. The connector further includes plurality of contact members that establish electrically conductive connections with tension members in the suspension member, wherein the at least one suspension member alignment feature aligns the contact members with the tension members.

### BACKGROUND

Elevator systems are in widespread use for carrying passengers between various levels in buildings, for example. Some elevator systems are traction-based in which a suspension assembly, sometimes referred to as roping, suspends the elevator car and a counterweight. The suspension assembly also facilitates movement of the elevator car when needed. Traditional suspension assemblies include round steel ropes. More recently, elevator systems have included other types of suspension members, such as flat belts or other types of ropes that have tension members encased in a compressible polymer jacket.

Traditional round steel ropes were typically inspected using a manual process including manually and visually observing the condition of the outer surfaces of the rope. Coated belts and other coated ropes cannot be inspected that way. Electrical inspection techniques have been developed that include applying electric current to at least some of the tension members and measuring an electrical characteristic, such as resistance, to obtain information indicating a condition of the belt or coated rope. Connectors are used to connect the coated belts to a monitoring device. Electrical connecting elements are to be properly aligned relative to the connector. The connection is determined by the interaction of several dimensions, which can result in mis-aligned connections.

### SUMMARY

An illustrative example connector includes: a body defining an internal cavity configured to receive a suspension member of an elevator system; at least one suspension member alignment feature formed on an inner wall surface that surrounds the internal cavity; and a plurality of contact members that establish electrically conductive connections with tension members in the suspension member, wherein the at least one suspension member alignment feature aligns the contact members with the tension members.

In addition to one or more of the features described above, or as an alternative, the at least one suspension member alignment feature comprises at least one contact surface that extends at an angle relative to the inner wall surface.

In addition to one or more of the features described above, or as an alternative, the at least one contact surface comprises a key that is centered within the internal cavity.

In addition to one or more of the features described above, or as an alternative, the at least one contact surface comprises at least one resilient finger.

In addition to one or more of the features described above, or as an alternative, the internal cavity is defined by a width extending from a first end wall of the internal cavity to a second end wall of the internal cavity that is opposite of the first end wall, and wherein the at least one contact surface comprises an angled surface that extends at an angle relative to the first end wall to provide a first end wall shape for the first end wall.

In addition to one or more of the features described above, or as an alternative, the second end wall has a second end wall shape that is different than the first end wall shape.

In addition to one or more of the features described above, or as an alternative, the body has a first wall, a second wall opposite the first wall, a first end wall connecting one end of the first wall to one end of the second wall, and a second end wall connecting an opposite end of the first wall to an opposite end of the second wall, and wherein one of the first wall and second wall includes a plurality of openings that each receive one contact member.

An illustrative example elevator system includes: an elevator car; at least one suspension member that supports the elevator car and facilitates movement of the elevator car; a connector defining an internal cavity that is enclosed by a plurality of walls, wherein a portion of the at least one suspension member extends into the internal cavity; at least one alignment feature formed within the internal cavity, the at least one alignment feature to directly engage the at least one suspension member; and a plurality of contact members that establish electrically conductive connections with tension members in the at least one suspension member, and wherein the at least one alignment feature aligns the contact members with the tension members.

In addition to one or more of the features described above, or as an alternative, the at least one alignment feature comprises at least one contact surface that extends at an angle relative to at least one wall surface of the plurality of walls that define the internal cavity.

In addition to one or more of the features described above, or as an alternative, the at least one contact surface comprises a key that is centered within the internal cavity.

In addition to one or more of the features described above, or as an alternative, the at least one contact surface comprises at least one resilient finger.

In addition to one or more of the features described above, or as an alternative, the at least one resilient finger comprises at least a pair of resilient fingers with one finger being on one side of the internal cavity and another finger being on an opposite side of the internal cavity.

In addition to one or more of the features described above, or as an alternative, the internal cavity is defined by a width extending from a first end wall of the plurality of walls to a second end wall of the plurality of walls that is opposite of the first end wall, and wherein the at least one contact surface comprises an angled surface that extends at an angle relative to the first end wall to provide a first end wall shape, and wherein the second end wall has a second end wall shape that is different than the first end wall shape.

In addition to one or more of the features described above, or as an alternative, the at least one suspension member comprises a first edge extending along a length of the at least one suspension member and a second edge that is opposite of the first edge, and wherein the first edge has a first edge shape that matches the first end wall shape and the second edge has a second edge shape that matches the second end wall shape.

In addition to one or more of the features described above, or as an alternative, the at least one suspension member comprises a flat belt including the tension members encased in a jacket, wherein at least one wall of the plurality of walls includes a plurality of openings to receive the contact members that directly engage with the at least one suspension member via the plurality of openings.

In addition to one or more of the features described above, or as an alternative, a center contact member of the plurality of contact members is aligned at a center of the at least one suspension member at a location that is between two adjacent tension members.

An illustrative example method of aligning a suspension member within an internal cavity of a connector includes: forming at least one alignment feature on an inner wall surface that surrounds the internal cavity; directly engaging a suspension member surface against the at least one alignment feature to provide a properly aligned position of the suspension member within the internal cavity; and establishing electrically conductive connections between a plurality of contact members and tension members in the suspension member in response to the at least one alignment feature aligning the contact members with the tension members.

In addition to one or more of the features described above, or as an alternative, the suspension member comprises a flat belt including the tension members encased in a jacket, and the method includes: inserting the contact members through a wall of the connector such that, when in the properly aligned position, a center contact member of the plurality of contact members is aligned at a center of the suspension member at a location that is between two adjacent tension members.

In addition to one or more of the features described above, or as an alternative, the method includes forming a first end wall of the internal cavity to have a first end wall shape to provide the at least one alignment feature, forming a second end wall of the internal cavity to have a second end wall shape different from the first end wall shape, forming a first longitudinal edge of the suspension member to have a first edge shape that matches the first end wall shape, and forming a second longitudinal edge of the suspension member to have a second edge shape that matches the second end wall shape.

In addition to one or more of the features described above, or as an alternative, the method includes forming at least one key or finger to extend outwardly of the inner wall surface to provide the at least one alignment feature.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 schematically illustrates a portion of an example suspension member.

FIG. 3A schematically illustrates one example of a cross-section of a connector.

FIG. 3B schematically illustrates a cross-section of a suspension member.

FIG. 3C schematically illustrates a cross-section of the suspension member of FIG. 3B as installed within the connector of FIG. 3A.

FIG. 3D schematically illustrates a top view of the suspension member and connector of FIG. 3C but with a portion of the connector removed.

FIG. 4A schematically illustrates another example of a cross-section of a connector.

FIG. 4B schematically illustrates a cross-section of a suspension member.

FIG. 4C schematically illustrates a cross-section of the suspension member of FIG. 4B as installed within the connector of FIG. 4A.

FIG. 4D schematically illustrates a top view of the suspension member and connector of FIG. 4C but with a portion of the connector removed.

FIG. 5A schematically illustrates a cross-section of another example of a suspension member as installed within a connector.

FIG. 5B schematically illustrates a top view of the suspension member and connector of FIG. 5A but with a portion of the connector removed.

FIG. 6 is a flowchart diagram of an example implementation of the method of alignment.

### DETAILED DESCRIPTION

Embodiments of this disclosure provide a connector with an internal cavity configured to receive a suspension member and an alignment feature formed on an inner wall surface that surrounds the internal cavity. The connector includes contact members that establish electrically conductive connections with tension members in the suspension member, with the alignment feature aligning the contact members with the tension members via a common reference. By creating a single common reference from which all tension members and contact members are dimensioned and controlled, the dependence on connector slot width, belt width, and cord-to-edge positioning can be removed from a tolerance stack.

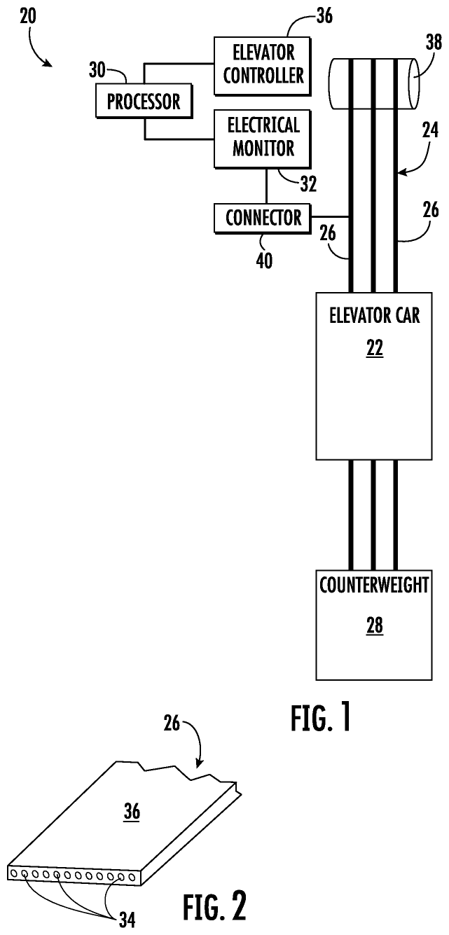

FIG. 1 schematically illustrates selected portions of an elevator system 20. An elevator car 22 is supported by a roping arrangement or suspension assembly 24 that includes a plurality of suspension members 26. The elevator car 22 is coupled to a counterweight 28 by the suspension members 26. The suspension members 26 move around a sheave 38 as the elevator car 22 moves between landings or levels.

A suspension member monitoring device includes at least one processor 30 that is configured to determine a condition of each of the suspension members 26. The processor 30 in the illustrated example includes a computing device and associated memory. The processor 30 is programmed or otherwise configured to use different types of information indicative of the respective conditions of the suspension members 26 and a combination of criteria to determine when it is desirable or necessary to remove any one of the suspension members 26 from service.

An electric-based monitor 32 uses an electrical inspection technique and generates or provides a corresponding indication regarding a condition of each suspension member 26. The processor 30 receives the indication from the electric-based monitor 32.

In some example embodiments, the electric-based monitor 32 is configured to apply electricity to at least one of the tension members, such as a steel cord, of each suspension member 26 and to detect or measure the electrical resistance of the tension member. Changes in the electrical resistance indicate changes in a condition of the suspension member 26. Such resistance-based inspection techniques are known and need not be further described here.

FIG. 2 schematically illustrates a portion of an example suspension member 26. In the illustrated embodiment, the suspension member 26 is a flat belt including a plurality of tension members 34 encased in a jacket 36 of a compressible material, such as polyurethane. In many embodiments, the tension members 34 comprise steel cords. Other embodiments include tension members that are made of different materials. The electrical inspection technique takes advantage of the electrically conductive nature of the tension members 34.

A connector 40 is used to connect the electric-based monitor 32 to an associated suspension member 26 (FIG. 1). In one example, the electric-based monitor 32 wirelessly communicates the electrical resistance information to the processor 30.

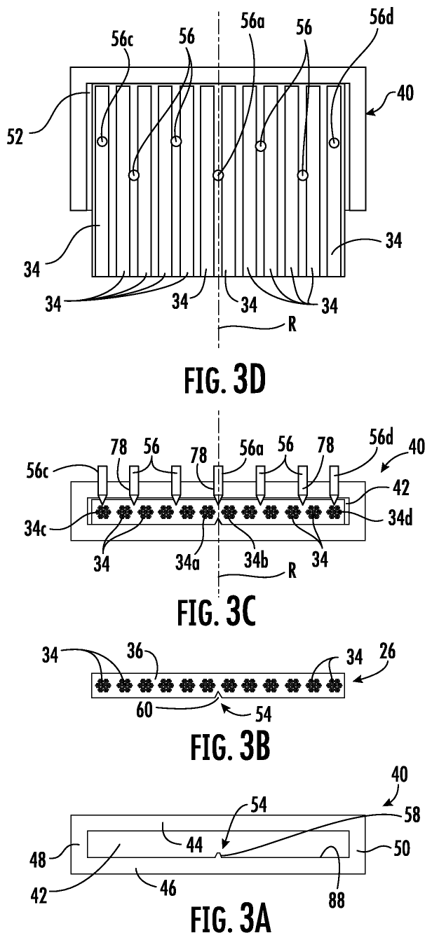

In one example, the connector 40 defines an internal cavity 42 that is enclosed by a plurality of walls. In one example shown in FIG. 3A, the plurality of walls include a first wall 44, a second wall 46 opposite the first wall 44, a first end wall 48 connecting one end of the first wall 44 to one end of the second wall 46, and a second end wall 50 connecting an opposite end of the first wall 44 to an opposite end of the second wall 46. The plurality of walls 44, 46, 48, 50 cooperate to completely surround and enclose the internal cavity 42. One portion 52 of the suspension member 26 extends into the internal cavity 42 as shown in FIG. 3D.

FIGS. 3A-3C show an example of an alignment feature 54 that is formed within the internal cavity 42. The at least one alignment feature 54 is configured to directly engage the suspension member 26. The connector 40 further includes a plurality of contact members 56 (FIG. 3C) that establish electrically conductive connections with the tension members 34 in the suspension member 26. The alignment feature 54 aligns the contact members 56 and the tension members 34 to a common reference R to reduce potential misalignment between the suspension member 26 and the contact members 56. If there is mis-alignment, one of the tension members 34 may not have an electrically conductive connection with one of the contact members 56, which would mean that there would be no electrical resistance information for that tension member 34.

In one example, the alignment feature 54 comprises at least one contact surface that extends at an angle relative to at least one wall surface of the plurality of walls 44, 46, 48, 50 that define the internal cavity 42. In one example, the contact surface comprises a small portion of a wall surface that extends at an angle relative to a main wall surface. In one example, the alignment feature 54 comprises a contact surface that is formed as at least one protrusion or recess within at least one wall surface of the plurality of walls that define the internal cavity 42.

FIGS. 3A-3C disclose an example where the contact surface of the alignment feature 54 comprises a key 58 that protrudes outwardly from the wall 46. In one example, the key 58 has a first surface extending at an angle relative to an inner wall surface 88 of the second wall 46, a second surface extending at an angle relative to the inner wall surface 88 of the second wall 46, and a third surface that connects the first and second surfaces. The alignment feature 54 further comprises a receiver area 60 that is formed within the suspension member 26 as shown in FIG. 3B. In one example, a cross-sectional shape of the receiver area 60 corresponds or matches to the cross-sectional shape of the key 58. In one example, the receiver area 60 is formed within the jacket 36 during production of the belt to extend along an entirety of a length of the suspension member 26. This would allow the connector 40 to be used anywhere on the suspension member 26.

In the example, shown in FIG. 3A, the key 58 has a trapezoidal cross-section; however, other cross-sectional shapes could also be used. For example, the key 58 could have a triangular cross-section, square cross-section, or any other polygonal shape. Additionally, the key 58 could have a curved cross-section or a cross-section having a combination of curved and linear shapes.

In one example, the key 58 is centered within the internal cavity 42 as shown in FIGS. 3A-3C. When the suspension member 26 is received within the internal cavity 42, the key 58 is inserted within the receiver area 60 as shown in FIG. 3C. Thus, this example uses a feature created during belt production that mates to a feature on the connector 40 to align to a common reference R.

In one example, a proper alignment comprises a configuration where each tension member 34 is in contact with one of the contact members 56 as shown in FIG. 3D. In one example, the contact members 56 comprise screws or other similar fastening elements. In one example, there are twelve tension members 34 and seven contact members 56. When properly aligned, a center contact member 56a is aligned at a center of the suspension member 26 at a location that is between two adjacent tension members 34a, 34b that are located at the middle of the suspension member 26. As such, one side of the center contact member 56a contacts tension member 34a and an opposite side of the center contact member 56a contacts tension member 34b. The edge tension members 34c, 34d each directly, and respectively, only engage with end contact members 56c, 56d. The remaining contact members 56 are aligned between adjacent tension members 34 such that one side of the contact member 56 contacts one tension member 34 and an opposite side of the contact member 56 contacts the other tension member 34. It should be understood that twelve tension members 34 and seven contact members 56 are shown as one example, and the number of tension and contact members can be varied as needed.

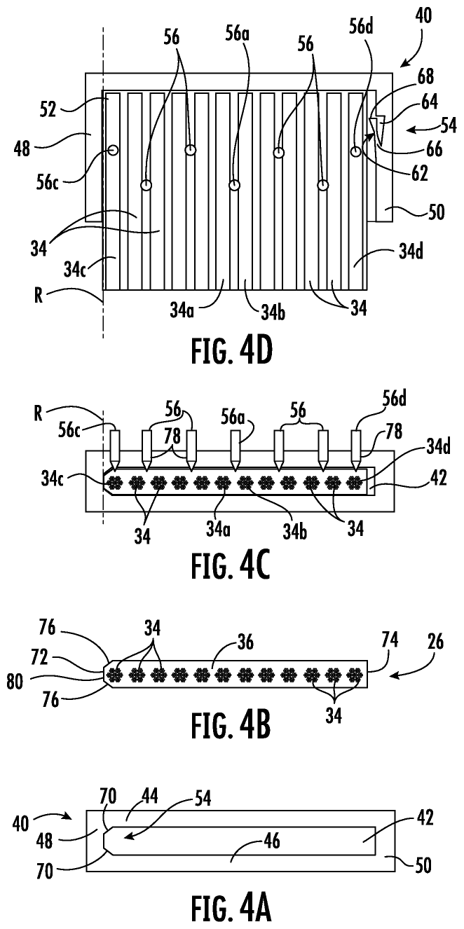

FIGS. 4A-4D disclose another example of an alignment feature 54. In this example, the angled contact surface of the alignment feature 54 comprises a contoured portion of one of the end walls 48, 50 that defines an asymmetric feature. The internal cavity 42 is defined by a width extending from the first end wall 48 to the second end wall 50. The contact surface comprises at least one angled surface 70 that extends at an angle relative to the first end wall 48 to provide a first end wall shape. In the example shown, the contact surface comprises two angled surfaces 70 that are connected to each other via a flat surface portion of the end wall 48. The angled surfaces 70 extend at non-parallel and non-perpendicular angles relative to the flat surface potion. The second end wall 50 has a second end wall shape that is different than the first end wall shape.

The suspension member 26 comprises a first edge 72 extending along a length of the suspension member 26 and a second edge 74 that is opposite of the first edge 72. In one example, the first edge 72 has a first edge shape that matches the first end wall shape and the second edge 74 has a second edge shape that matches the second end wall shape. This means that the suspension member 26 can only be installed in one orientation within the connector 40. In one example, the first edge 72 has angled surfaces 76 connected to each other by a straight surface 80 to form a shape common with the first end wall shape. In one example, the second edge 74 has a squared-off shape to match the squared-off end of the second end wall 50. It should be understood that other shapes could also be used.

In one example, at least one resilient finger 62 is additionally used as a compliant feature to hold the first edge 72 of the suspension member in direct engagement with the first end wall 48 to achieve proper alignment. Thus, in this example, the alignment feature 54 comprises an asymmetric feature that is added to the suspension member 26 that allows only one installation orientation in combination with using a compliant feature to align to a common reference R.

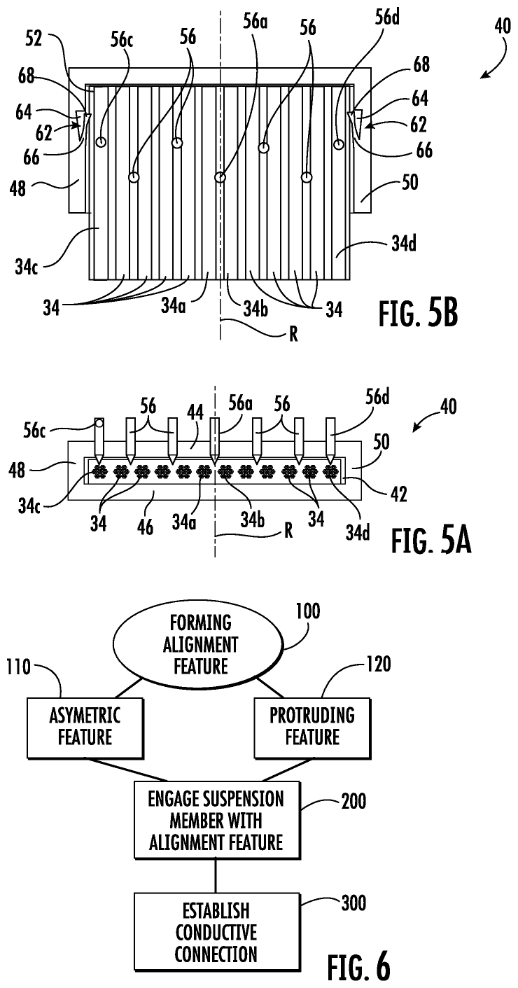

FIGS. 5A-5B disclose another example of an alignment feature 54. In this example, the angled contact surface of the alignment feature 54 comprises at least one resilient finger 62. In this example, the resilient finger 62 is formed within one of the first 48 and second 50 end walls. In one example, the at least one finger 62 comprises at least a pair of resilient fingers 62 with one finger 62 being on one side of the internal cavity 42 and another finger 62 being on an opposite side of the internal cavity 42 as shown in FIG. 5B.

In one example, a recess 64 for each finger 62 is formed within the associated end wall 48, 50 to be associated with the respective finger 62. In one example, the finger 62 has a first end 66 that is held fixed within the recess 62, and extends to a cantilevered distal end 68 that is moveable between an uninstalled position and an installed position. The finger 62 is resiliently biased to an outward position within the internal cavity 42 when the suspension member 26 is in the uninstalled position. When the suspension member 26 is in the installed position (FIG. 5B), the fingers 62 are pressed outwardly away from each other and toward their respective recesses 64 by opposing edges 72, 74 of the suspension member 26. Thus, in this example, the fingers 62 comprise a compliant feature that resiliently grips and centers the suspension member 26 in the properly aligned position relative to the common reference R. In this position, the contact members 56 are aligned relative to the tension members 34 in a manner similar to that described above with regard to FIG. 3D.

FIG. 6 is a flowchart diagram of an example implementation of the method of alignment. In one example, a method of aligning a suspension member 26 within an internal cavity 42 of a connector 40 includes forming at least one alignment feature 54 on an inner wall surface that surrounds the internal cavity 42 as indicated at step 100. Next, a suspension member surface is directly engaged with the at least one alignment feature 54 to provide a properly aligned position of the suspension member 26 within the internal cavity 42 as indicated at step 200. Next, electrically conductive connections are established between the contact members 56 and tension members 34 in the suspension member 26 in response to the at least one alignment feature 54 aligning the contact members 56 with the tension members 34 as indicated at step 300.

In one example, one wall of the plurality of walls 44, 46, 48, 50 is formed to have openings 78 to receive the contact members 56 that directly engage with the tension members 34. In one example, step 300 of the method further includes inserting the contact members 56 through the wall of the connector 40 such that, when in the properly aligned position, a center contact member 56a of the plurality of contact members 56 is aligned at a center of the suspension member 26 at a location that is between two adjacent tension members 34a, 34b.

In one example, forming the at least one alignment feature 54 comprises forming an asymmetric feature as set forth at step 110. In one example, step 110 includes: forming a first end wall of the internal cavity to have a first end wall shape to provide the at least one alignment feature; forming a second end wall of the internal cavity to have a second end wall shape different from the first end wall shape; forming a first longitudinal edge of the suspension member to have a first edge shape that matches the first end wall shape; and forming a second longitudinal edge of the suspension member to have a second edge shape that matches the second end wall shape.

In another example, forming the at least one alignment feature 54 comprises forming a protruding feature as set forth at step 120. In one example, step 120 includes forming at least one key or finger to extend outwardly of the inner wall surface to provide the at least one alignment feature.

Current resistance based inspection connectors and belt production process capabilities present a narrow design window to ensure contact members of the connector can properly mate with the tension members. The connection success is determined by the interaction of several dimensions. Future designs are likely to tighten the window further which will require additional measures to improve alignment. The subject disclosure provides several methods for reducing potential misalignment between the contact members and the tension members. These methods include using mating male/female features on the connector and suspension member, using compliant features inside the connector to center the suspension member, or adding a feature to ensure one installation orientation while using a compliant feature to align to a common reference. By creating a single common reference from which all tension members on the suspension member and contact members on the connector are dimensioned and controlled, the dependence on dimensions such as the connector slot width, suspension member width, and tension member to edge positioning can be removed from the tolerance stack.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A connector comprising:
a body defining an internal cavity configured to receive a suspension member of an elevator system;
at least one suspension member alignment feature formed on an inner wall surface that surrounds the internal cavity; and
a plurality of contact members that establish electrically conductive connections with tension members in the suspension member, wherein the at least one suspension member alignment feature aligns the contact members with the tension members.

2. The connector of claim 1, wherein the at least one suspension member alignment feature comprises at least one contact surface that extends at an angle relative to the inner wall surface.

3. The connector of claim 2, wherein the at least one contact surface comprises a key that is centered within the internal cavity.

4. The connector of claim 2, wherein the at least one contact surface comprises at least one resilient finger.

5. The connector of claim 2, wherein the internal cavity is defined by a width extending from a first end wall of the internal cavity to a second end wall of the internal cavity that is opposite of the first end wall, and wherein the at least one contact surface comprises an angled surface that extends at an angle relative to the first end wall to provide a first end wall shape for the first end wall.

6. The connector of claim 5, wherein the second end wall has a second end wall shape that is different than the first end wall shape.

7. The connector of claim 1, wherein the body has a first wall, a second wall opposite the first wall, a first end wall connecting one end of the first wall to one end of the second wall, and a second end wall connecting an opposite end of the first wall to an opposite end of the second wall, and wherein one of the first wall and second wall includes a plurality of openings that each receive one contact member.

8. An elevator system, comprising:
an elevator car;
at least one suspension member that supports the elevator car and facilitates movement of the elevator car;
a connector defining an internal cavity that is enclosed by a plurality of walls, wherein a portion of the at least one suspension member extends into the internal cavity;
at least one alignment feature formed within the internal cavity, the at least one alignment feature to directly engage the at least one suspension member; and
a plurality of contact members that establish electrically conductive connections with tension members in the at least one suspension member, and wherein the at least one alignment feature aligns the contact members with the tension members.

9. The elevator system of claim 8, wherein the at least one alignment feature comprises at least one contact surface that extends at an angle relative to at least one wall surface of the plurality of walls that define the internal cavity.

10. The elevator system of claim 9, wherein the at least one contact surface comprises a key that is centered within the internal cavity.

11. The elevator system of claim 9, wherein the at least one contact surface comprises at least one resilient finger.

12. The elevator system of claim 11, wherein the at least one resilient finger comprises at least a pair of resilient fingers with one finger being on one side of the internal cavity and another finger being on an opposite side of the internal cavity.

13. The elevator system of claim 9, wherein the internal cavity is defined by a width extending from a first end wall of the plurality of walls to a second end wall of the plurality of walls that is opposite of the first end wall, and wherein the at least one contact surface comprises an angled surface that extends at an angle relative to the first end wall to provide a first end wall shape, and wherein the second end wall has a second end wall shape that is different than the first end wall shape.

14. The elevator system of claim 13, wherein the at least one suspension member comprises a first edge extending along a length of the at least one suspension member and a second edge that is opposite of the first edge, and wherein the first edge has a first edge shape that matches the first end wall shape and the second edge has a second edge shape that matches the second end wall shape.

15. The elevator system of claim 8, wherein the at least one suspension member comprises a flat belt including the tension members encased in a jacket, wherein at least one wall of the plurality of walls includes a plurality of openings to receive the contact members that directly engage with the at least one suspension member via the plurality of openings.

16. The elevator system of claim 15, wherein a center contact member of the plurality of contact members is aligned at a center of the at least one suspension member at a location that is between two adjacent tension members.

17. A method of aligning a suspension member within an internal cavity of a connector, the method comprising:
forming at least one alignment feature on an inner wall surface that surrounds the internal cavity;
directly engaging a suspension member surface against the at least one alignment feature to provide a properly aligned position of the suspension member within the internal cavity; and
establishing electrically conductive connections between a plurality of contact members and tension members in the suspension member in response to the at least one alignment feature aligning the contact members with the tension members.

18. The method of claim 17, wherein the suspension member comprises a flat belt including the tension members encased in a jacket, and including:
inserting the contact members through a wall of the connector such that, when in the properly aligned position, a center contact member of the plurality of contact members is aligned at a center of the suspension member at a location that is between two adjacent tension members.

19. The method of claim 17, including forming a first end wall of the internal cavity to have a first end wall shape to provide the at least one alignment feature, forming a second end wall of the internal cavity to have a second end wall shape different from the first end wall shape, forming a first longitudinal edge of the suspension member to have a first edge shape that matches the first end wall shape, and forming a second longitudinal edge of the suspension member to have a second edge shape that matches the second end wall shape.

20. The method of claim 17, including forming at least one key or finger to extend outwardly of the inner wall surface to provide the at least one alignment feature.
